(19) United States
(12) Patent Application Publication
(10) Pub. No.: US 2026/0045518 A1
(43) Pub. Date: Feb. 12, 2026

(54) CATALYTICALLY ACTIVE ATOMIC LAYERS FOR ELECTRODES OF REVERSIBLE SOLID OXIDE CELLS

(71) Applicant: West Virginia University Board of Governors on Behalf of West Virginia University, Morgantown, WV (US)

(72) Inventors: Hanchen Tian, Morgantown, WV (US); Xingbo Liu, Morgantown, WV (US)

(21) Appl. No.: 19/221,729

(22) Filed: May 29, 2025

Related U.S. Application Data
(60) Provisional application No. 63/681,904, filed on Aug. 12, 2024.

(51) Int. Cl. H01M 4/90; H01M 4/88; H01M 8/12

(52) U.S. Cl. CPC H01M 4/9033; H01M 4/8867; H01M 4/9075; H01M 8/12; H01M 2008/1293

(57) ABSTRACT

In one aspect, the disclosure relates to electrodes with a Ruddlesden-Popper phase scaffold and a catalyst coating, symmetrical cells and single electrochemical cells comprising the same, and devices incorporating the same. The Ruddlesden-Popper phase scaffold can be or include Pr₂₋ₓBaₓNiO_{4+δ}, wherein 0≤x≤0.4, while the catalyst coating can be a transition metal, transition metal oxide, or perovskite material applied to the scaffold using atomic layer deposition or another means. In an aspect, the catalyst coating can be conformal or non-conformal.

### CROSS-REFERENCE TO RELATED APPLICATIONS

This application claims the benefit of U.S. Provisional Application Ser. No. 63/681,904, filed Aug. 12, 2024, which is incorporated herein by reference in its entirety.

### STATEMENT REGARDING FEDERALLY SPONSORED RESEARCH OR DEVELOPMENT

This invention was made with government support under grant number DE-EED008378 awarded by the United States Department of Energy. The government has certain rights in the invention.

### BACKGROUND

Reversible solid oxide cells, having a low cost and high round-trip efficiency, provide an alternative to batteries, proton exchange membrane fuel cells, and other similar devices. Lower operation temperature can greatly reduce the system complexity and increase the service life. However, current air electrode of solid oxide cells suffer from catalytical deactivation at reduced operating temperatures. The exacerbated polarization resistance deterioration of air electrodes raises the cost of using reversible solid oxide cells as energy conversion system and limits their practical use to the laboratory.

Using current strategies, such as in situ exsolution and infiltration, it is difficult to control the morphology and composition of nanocatalyst particles, and the introduced nanocatalyst particles partially cover the substrate surface, showing a nano composite morphology, which is not a robust solution. Accordingly, new strategies are needed to rationally design and finely construct highly catalytic surfaces based on highly conductive materials.

Despite advances in reversible solid oxide cell research, there is still a lack of suitable materials for producing reversible solid oxide cells that are robust, sustainable, inexpensive, and able to function at reduced operating temperatures without suffering from catalytical degradation. Ideal materials and devices would be scalable for industrial production and use, would have long-term operational stability, and would meet established standards. These needs and other needs are satisfied by the present disclosure.

### SUMMARY

In accordance with the purpose(s) of the present disclosure, as embodied and broadly described herein, the disclosure, in one aspect, relates to electrodes with a Ruddlesden-Popper phase scaffold and a catalyst coating, symmetrical cells and single electrochemical cells comprising the same, and devices incorporating the same. The Ruddlesden-Popper phase scaffold can be or include Pr₂₋ₓBaₓNiO_{4+δ}, wherein 0≤x≤0.4, while the catalyst coating can be a transition metal, transition metal oxide, or perovskite material applied to the scaffold using atomic layer deposition or another means. In an aspect, the catalyst coating can be conformal or non-conformal.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims. In addition, all optional and preferred features and modifications of the described embodiments are usable in all aspects of the disclosure taught herein. Furthermore, the individual features of the dependent claims, as well as all optional and preferred features and modifications of the described embodiments are combinable and interchangeable with one another.

### BRIEF DESCRIPTION OF THE DRAWINGS

Many aspects of the present disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1A shows a schematic illustration of catalytically active atomic layers for electrodes of Reversible Solid Oxide Cells. FIG. 1B shows transmission electron microscopy characterization of atomic layer deposition (ALD)-prepared Co atomic layers. FIG. 1C shows X-ray photoelectron spectra of Co atomic layers of different thicknesses

FIG. 2 shows the effect of the addition of different cations (10 and 20 ALD cycles) on the Rₚ of Pr_{1.8}Ba_{0.2}Ni_{1.0}O_{4-δ} (PBNO) electrode at 550° C. in a 40 vol. % balanced by air environment.

FIGS. 3A-3E show Nyquist electrochemical impedance spectroscopy (EIS) plots of pristine Ni∥BCZYY1b1711∥PBNO cell and Co deposited cell obtained at various temperatures under open-circuit voltage (OCV) conditions.

FIGS. 4A-4B show a comparison of the current-voltage characteristic (I-V) curves of a fuel electrode-supported cell with PBNO air electrode and Co deposited PBNO air electrode.

FIGS. 5A-5B show performance enhancements of a fuel electrode-supported cell with PBNO air electrode and Co deposited PBNO air electrode in (FIG. 5B) fuel cell mode and (FIG. 5A) electrolysis mode.

FIG. 6 shows a simulation on the effect of Co deposition using a decrease of proton-related reaction activity (exchange rate constant) and a decrease of the effective surface-active site for proton-related species adsorption (equilibrium H₂O and H⁺ coverages).

Additional advantages of the invention will be set forth in part in the description which follows, and in part will be obvious from the description, or can be learned by practice of the invention. The advantages of the invention will be realized and attained by means of the elements and combinations particularly pointed out in the appended claims. It is to be understood that both the foregoing general description and the following detailed description are exemplary and explanatory only and are not restrictive of the invention, as claimed.

### DETAILED DESCRIPTION

Disclosed herein are reversible solid oxide cells and catalytically active atomic layers. Also disclosed is a method for enhancing oxygen reduction reaction kinetics using a nanoscale interfacial hybrid layer composed of a conformal amorphous film on porous electrodes. In one aspect, the disclosed method can significantly enhance the performance of reversible solid oxide cells by applying a coating of a catalyst layer using an atomic layer deposition process or another method. In some aspects, the catalyst coating can be conformal or non-conformal. In a further aspect, the desired atomic layers have different composition from the substrate electrode and serve as active sites on the surface of the electrode, promoting the kinetic rate of elementary reactions such as adsorption and dissociation without changing the intrinsic conductivity of the substrate. In a still further aspect, the disclosed reversible solid oxide cells can break through the deactivation caused by lowering the operation temperature of the disclosed devices and methods and extend the system lifetime, enabling broad commercialization of solid oxide cell technology, which has heretofore not been achieved.

In an aspect, the present disclosure provides construction of a nano and/or sub-nano conformally Co atomic layer on the surface of a cobalt-free electrode. Resulting current density enhancement of up to 55%, 110%, 95%, and 40% at 450° C. 500° C. 550° C., and 600° C., respectively, can be achieved.

In one aspect, surface catalysis and bulk phase conduction have different demands on the intrinsic properties of materials. In a further aspect, the proton conductivity and surface catalytic properties of triple conducting electrodes (TCOs) are interrelated or even inverted, which introduces an upper performance limit for air electrodes with doped elements. In one aspect, as disclosed herein, differentially constructing surface catalytic materials and bulk-phase conductive materials are effective ways to enhance performance. Current technologies for enhancing composite electrodes include using several hundred nanometers of “low-catalytic high-conductivity materials” and several tens of nanometers of “high-catalytic low-conductivity materials” by means of in-situ exsolution and impregnation to meet the different demands of surface catalytic materials and bulk-phase conductive materials for the electrodes. In a further aspect, the respective catalytic and conductive properties of the two composites are still interrelated or even inverted, respectively, which is similar to that of the traditional doping control.

In one aspect, the disclosed catalytically active atomic layers for electrodes show desirable activity and are applicable for use high-temperature electrochemical devices such as, for example, solid oxide fuel cells (SOFCs), protonic conducting fuel cells (PCFCs), and protonic conducting electrolysis cells (PCECs), as well as low-temperature electrochemical devices such as, for example, proton exchange membrane fuel cells (PEMFCs), rechargeable metal-air batteries, and water splitting devices.

### Electrodes

In one aspect, disclosed herein is an electrode including a Ruddlesden-Popper phase scaffold and a catalyst coating. In some aspects, the Ruddlesden-Popper phase scaffold can include Pr₂₋ₓBaₓNiO_{4+δ}, wherein 0≤x≤0.4. In one aspect, the Ruddlesden-Popper phase scaffold can be or include Pr_{1.8}Ba_{0.2}NiO_{4.1} (PBNO).

In some aspects, the catalyst coating includes a transition metal such as, for example, cobalt, iron, praseodymium, an alloy thereof, or any combination thereof. In an alternative aspect, the catalyst coating can include a metal oxide or transition metal oxide or a perovskite material. In one aspect, the transition metal is cobalt. In any of these aspects, the catalyst coating can be conformal or non-conformal. In a further aspect, the conformal catalyst coating forms a continuous, uniform film over the scaffold. In one aspect, the transition metal is deposited by a technique such as, for example, atomic layer deposition (ALD). In another aspect, about 2 to about 50 ALD cycles are performed, or about 2, 5, 10, 15, 20, 25, 30, 35, 40, 45, or about 50 ALD cycles are performed. In another aspect, 20 ALD cycles are performed. In one aspect, the perovskite material can have a formula AB(O₃), wherein A comprises praseodymium, lanthanum, or a combination thereof, and wherein B comprises a second transition metal. In a further aspect, the second transition metal can be cobalt, iron, or any combination thereof.

In yet another aspect, the film is less than about 20 μm thick, or less than about 15 μm thick, or less than about 10 μm thick.

### Symmetrical Cells

Also disclosed herein are symmetrical cells including the electrode described herein. In an aspect, a symmetrical cell has identical electrodes on each end and an electrolyte between the electrodes. In some aspects, in the disclosed cells, the electrolyte can be a perovskite phase electrolyte material. In a further aspect, the perovskite phase electrolyte material can be or include BaZrₓCe_{y}Y_{z}Yb_{(1-x-y-z¬)}O_{3-δ}, wherein 0.1≤x≤0.8, wherein 0≤y≤0.8, and wherein 0≤z≤0.3. Further in this aspect, the perovskite phase electrolyte material can be BaZr_{0.1}Ce_{0.7}Y_{0.1}Yb_{0.1}O_{3-δ} (BZCYYb1711), BaZr_{0.4}Ce_{0.4}Y_{0.1}Yb_{0.1}O_{3-δ} (BZCYYb4411), or a combination thereof.

In one aspect, the symmetrical cell can include an Au current collector. In an aspect, the Au current collector can be formed by applying an Au paste to the electrodes on each side of the symmetrical cell. In another aspect, the symmetrical cell can also include one or more Ag lead wires.

In a further aspect, the symmetrical cell can have a polarization resistance of less than about 0.2 Ω·cm². In some aspects, the final polarization resistance after about 200 hours of operation is no more than about 10% greater than the initial polarization resistance of the cell. Further in this aspect, the initial polarization resistance and the final polarization resistance can be measured in an environment containing from about 30 vol % to about 60 vol % H₂O in air, or about 30, 35, 40, 45, 50, 55, or about 60 vol % H₂O in air.

In yet another aspect, operation of the symmetrical cell includes repeated thermal cycles from a first temperature to a second temperature and back to the first temperature. In one aspect, the first temperature can be about 100° C. and the second temperature can be from about 500 to about 550° C. In a further aspect, 500 to 550° C. is a lower second temperature than for previously known electrodes. In an aspect, performance of the cell does not degrade even during operation at lower temperatures.

### Single Electrochemical Cells

Also disclosed herein is a single electrochemical cell including the disclosed electrodes. In an aspect, the single electrochemical cell also includes a fuel electrode support, wherein the fuel electrode support can include NiO, one or more perovskite precursors, and a pore former. In one aspect, the one or more perovskite precursors include Ba, Ce, Zr, Y, and Yb (BZCYYb). In another aspect, the NiO, the BZCYYb, and the pore former can be present in a ratio of about 5:5:2 by weight. In one aspect, the pore former can be starch.

In an aspect, the single electrochemical cell can also include a perovskite phase electrolyte material such as, for example, BaZrₓCe_{y}Y_{z}Yb_{(1-x-y-z¬)}O_{3-δ}, wherein 0.1≤x≤0.8, wherein 0≤y≤0.8, and wherein 0≤z≤0.3. In a further aspect, the perovskite phase electrolyte material can be BaZr_{0.1}Ce_{0.7}Y_{0.1}Yb_{0.1}O_{3-δ} (BZCYYb1711), BaZr_{0.4}Ce_{0.4}Y_{0.1}Yb_{0.1}O_{3-δ} (BZCYYb4411), or a combination thereof.

### Devices Incorporating the Cells

Furthermore, disclosed herein are devices including the disclosed symmetrical cells and/or single electrochemical cells. In one aspect, the device can be a fuel cell, an electrolysis cell, a battery, a water splitting device, or any combination thereof. In a further aspect, when the device is or includes a fuel cell, the fuel cell can be a solid oxide fuel cell, a protonic conducting fuel cell, a proton exchange membrane fuel cell, or any combination thereof.

Many modifications and other embodiments disclosed herein will come to mind to one skilled in the art to which the disclosed compositions and methods pertain having the benefit of the teachings presented in the foregoing descriptions and the associated drawings. Therefore, it is to be understood that the disclosures are not to be limited to the specific embodiments disclosed and that modifications and other embodiments are intended to be included within the scope of the appended claims. The skilled artisan will recognize many variants and adaptations of the aspects described herein. These variants and adaptations are intended to be included in the teachings of this disclosure and to be encompassed by the claims herein.

Although specific terms are employed herein, they are used in a generic and descriptive sense only and not for purposes of limitation.

As will be apparent to those of skill in the art upon reading this disclosure, each of the individual embodiments described and illustrated herein has discrete components and features which may be readily separated from or combined with the features of any of the other several embodiments without departing from the scope or spirit of the present disclosure.

Any recited method can be carried out in the order of events recited or in any other order that is logically possible. That is, unless otherwise expressly stated, it is in no way intended that any method or aspect set forth herein be construed as requiring that its steps be performed in a specific order. Accordingly, where a method claim does not specifically state in the claims or descriptions that the steps are to be limited to a specific order, it is no way intended that an order be inferred, in any respect. This holds for any possible non-express basis for interpretation, including matters of logic with respect to arrangement of steps or operational flow, plain meaning derived from grammatical organization or punctuation, or the number or type of aspects described in the specification.

All publications mentioned herein are incorporated herein by reference to disclose and describe the methods and/or materials in connection with which the publications are cited. The publications discussed herein are provided solely for their disclosure prior to the filing date of the present application. Nothing herein is to be construed as an admission that the present invention is not entitled to antedate such publication by virtue of prior invention. Further, the dates of publication provided herein can be different from the actual publication dates, which can require independent confirmation.

While aspects of the present disclosure can be described and claimed in a particular statutory class, such as the system statutory class, this is for convenience only and one of skill in the art will understand that each aspect of the present disclosure can be described and claimed in any statutory class.

It is also to be understood that the terminology used herein is for the purpose of describing particular aspects only and is not intended to be limiting. Unless defined otherwise, all technical and scientific terms used herein have the same meaning as commonly understood by one of ordinary skill in the art to which the disclosed compositions and methods belong. It will be further understood that terms, such as those defined in commonly used dictionaries, should be interpreted as having a meaning that is consistent with their meaning in the context of the specification and relevant art and should not be interpreted in an idealized or overly formal sense unless expressly defined herein.

Prior to describing the various aspects of the present disclosure, the following definitions are provided and should be used unless otherwise indicated. Additional terms may be defined elsewhere in the present disclosure.

### Definitions

As used herein, “comprising” is to be interpreted as specifying the presence of the stated features, integers, steps, or components as referred to, but does not preclude the presence or addition of one or more features, integers, steps, or components, or groups thereof. Moreover, each of the terms “by”, “comprising,” “comprises”, “comprised of,” “including,” “includes,” “included,” “involving,” “involves,” “involved,” and “such as” are used in their open, non-limiting sense and may be used interchangeably. Further, the term “comprising” is intended to include examples and aspects encompassed by the terms “consisting essentially of” and “consisting of.” Similarly, the term “consisting essentially of” is intended to include examples encompassed by the term “consisting of.

As used in the specification and the appended claims, the singular forms “a,” “an” and “the” include plural referents unless the context clearly dictates otherwise. Thus, for example, reference to “a pore former,” “a chelating agent,” or “an electrolyte,” include, but are not limited to, mixtures or combinations of two or more such pore formers, chelating agents, or electrolytes, and the like.

It should be noted that ratios, concentrations, amounts, and other numerical data can be expressed herein in a range format. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. Ranges can be expressed herein as from “about” one particular value, and/or to “about” another particular value. Similarly, when values are expressed as approximations, by use of the antecedent “about,” it will be understood that the particular value forms a further aspect. For example, if the value “about 10” is disclosed, then “10” is also disclosed.

When a range is expressed, a further aspect includes from the one particular value and/or to the other particular value. For example, where the stated range includes one or both of the limits, ranges excluding either or both of those included limits are also included in the disclosure, e.g. the phrase “x to y” includes the range from ‘x’ to ‘y’ as well as the range greater than ‘x’ and less than ‘y’. The range can also be expressed as an upper limit, e.g. ‘about x, y, z, or less' and should be interpreted to include the specific ranges of ‘about x’, ‘about y’, and ‘about z’ as well as the ranges of ‘less than x’, less than y’, and ‘less than z’. Likewise, the phrase ‘about x, y, z, or greater’ should be interpreted to include the specific ranges of ‘about x’, ‘about y’, and ‘about z’ as well as the ranges of ‘greater than x’, greater than y’, and ‘greater than z’. In addition, the phrase “about ‘x’ to ‘y’”, where ‘x’ and ‘y’ are numerical values, includes “about ‘x’ to about ‘y’”.

It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a numerical range of “about 0.1% to 5%” should be interpreted to include not only the explicitly recited values of about 0.1% to about 5%, but also include individual values (e.g., about 1%, about 2%, about 3%, and about 4%) and the sub-ranges (e.g., about 0.5% to about 1.1%; about 5% to about 2.4%; about 0.5% to about 3.2%, and about 0.5% to about 4.4%, and other possible sub-ranges) within the indicated range.

As used herein, the terms “about,” “approximate,” “at or about,” and “substantially” mean that the amount or value in question can be the exact value or a value that provides equivalent results or effects as recited in the claims or taught herein. That is, it is understood that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art such that equivalent results or effects are obtained. In some circumstances, the value that provides equivalent results or effects cannot be reasonably determined. In such cases, it is generally understood, as used herein, that “about” and “at or about” mean the nominal value indicated ±10% variation unless otherwise indicated or inferred. In general, an amount, size, formulation, parameter or other quantity or characteristic is “about,” “approximate,” or “at or about” whether or not expressly stated to be such. It is understood that where “about,” “approximate,” or “at or about” is used before a quantitative value, the parameter also includes the specific quantitative value itself, unless specifically stated otherwise.

As used herein, the terms “optional” or “optionally” means that the subsequently described event or circumstance can or cannot occur, and that the description includes instances where said event or circumstance occurs and instances where it does not.

As used herein, “PBNO” refers to a compound having the formula Pr₂₋ₓBaₓNiO_{4+δ}, wherein 0≤x≤0.4, such as, for example, Pr_{1.8}Ba_{0.2}Ni_{1.0}O_{4-δ}, while “BZCYYb1711” refers to BaZr_{0.1}Ce_{0.7}Y_{0.1}Yb_{0.1}O_{3-δ} and “BZCYYb4411” refers to BaZr_{0.4}Ce_{0.4}Y_{0.1}Yb_{0.1}O_{3-δ}.

When used in a subscript of a chemical formula herein, 5 indicates that during the course of normal use for a device containing a given chemical species such as a catalyst, perovskite, or the like, the amount of the atom with a subscript 6 in the chemical species may vary and can thus be present in a nonstoichiometric amount. For example, Pr₂₋ₓBaₓNiO_{4+δ} indicates that greater than stoichiometric amounts of oxygen may sometimes be present during a given stage in a process, while BaZrₓCe_{y}Y_{z}Yb_{(1-x-y-z)}O_{3-δ} indicates that less than stoichiometric amounts of oxygen may sometimes be present.

“Atomic layer deposition” or “ALD” as used herein refers to a method of thin film deposition in which a coating layer grows one atom's thickness at a time. ALD is a variety of chemical vapor deposition. In one aspect, the conformal coatings on the disclosed electrodes are formed using ALD.

A “reversible solid oxide cell” as used herein refers to a solid-stat device that can be operated as either a solid oxide fuel cell (SOFC) and a solid oxide electrolysis cell (SOEC). In an aspect, a reversible solid oxide cell can be a symmetrical cell with two electrodes on either side of a dense electrolyte. In one aspect, traditional reversible solid oxide cells operate at high temperature ranges (600° C. to 900° C.) and can degrade when operated at lower temperatures.

However, the presently disclosed symmetrical cells are capable of long term stable operation at temperatures lower than 600° C.

Unless otherwise specified, temperatures referred to herein are based on atmospheric pressure (i.e. one atmosphere).

Now having described the aspects of the present disclosure, in general, the following Examples describe some additional aspects of the present disclosure. While aspects of the present disclosure are described in connection with the following examples and the corresponding text and figures, there is no intent to limit aspects of the present disclosure to this description. On the contrary, the intent is to cover all alternatives, modifications, and equivalents included within the spirit and scope of the present disclosure.

### ASPECTS

The present disclosure can be described in accordance with the following numbered aspects, which should not be confused with the claims.

Aspect 1. An electrode comprising a Ruddlesden-Popper phase scaffold and a catalyst coating.

Aspect 2. The electrode of aspect 1, wherein the Ruddlesden-Popper phase scaffold comprises Pr₂₋ₓBaₓNiO_{4+δ}, wherein 0≤x≤0.4.

Aspect 3. The electrode of aspect 1 or 2, wherein the Ruddlesden-Popper phase scaffold comprises Pr_{1.8}Ba_{0.2}NiO_{4.1} (PBNO).

Aspect 4. The electrode of any one of aspects 1-3, wherein the catalyst coating comprises a transition metal, a transition metal oxide, or a perovskite.

Aspect 5. The electrode of aspect 4, wherein the transition metal comprises cobalt, iron, praseodymium, an alloy thereof, or any combination thereof.

Aspect 6. The electrode of aspect 4 or 5, wherein the transition metal is cobalt.

Aspect 7. The electrode of aspect 4, wherein the perovskite has a formula AB(O₃), wherein A comprises praseodymium, lanthanum, or a combination thereof, and wherein B comprises a second transition metal.

Aspect 8. The electrode of aspect 7, wherein the second transition metal comprises cobalt, iron, or a combination thereof.

Aspect 9. The electrode of any one of aspects 1-8, wherein the catalyst coating comprises a conformal catalyst coating or a non-conformal catalyst coating.

Aspect 10. The electrode of aspect 9 wherein the conformal catalyst coating forms a continuous, uniform film over the scaffold.

Aspect 11. The electrode of any one of aspects 4-10, wherein from the transition metal has been deposited by atomic layer deposition (ALD).

Aspect 12. The electrode of aspect 11, wherein from about 2 to about 50 ALD cycles have been performed.

Aspect 13. The electrode of aspect 11 or 12, wherein about 20 ALD cycles have been performed.

Aspect 14. The electrode of any one of aspects 11-13, wherein the film is less than about 20 μm thick.

Aspect 15. The electrode of any one of aspects 11-14, wherein the film is less than about 10 μm thick.

Aspect 16. A symmetrical cell comprising the electrode of any one of aspects 1-15.

Aspect 17. The symmetrical cell of aspect 16, further comprising a perovskite phase electrolyte material.

Aspect 18. The symmetrical cell of aspect 17, wherein the perovskite phase electrolyte material comprises BaZrₓCe_{y}Y_{z}Yb_{(1-x-y-z¬)}O_{3-δ}, wherein 0.1≤x≤0.8, wherein 0≤y≤0.8, and wherein 0≤z≤0.3.

Aspect 19. The symmetrical cell of aspect 16 or 17, wherein the perovskite phase electrolyte material comprises BaZr_{0.1}Ce_{0.7}Y_{0.1}Yb_{0.1}O_{3-δ} (BZCYYb1711), BaZr_{0.4}Ce_{0.4}Y_{0.1}Yb_{0.1}O_{3-δ} (BZCYYb4411), or a combination thereof.

Aspect 20. The symmetrical cell of any one of aspects 16-19, further comprising an Au current collector.

Aspect 21. The symmetrical cell of any one of aspects 16-20, further comprising an Ag lead wire.

Aspect 22. The symmetrical cell of any one of aspects 16-21, wherein the symmetrical cell has a polarization resistance less than about 0.2 Ω·cm².

Aspect 23. The symmetrical cell of any one of aspects 16-22, wherein a final polarization resistance after 200 hours of operation is no more than about 10% greater than an initial polarization resistance.

Aspect 24. The symmetrical cell of aspect 23, wherein the initial polarization resistance and the final polarization resistance are measured in an environment containing from about 30 vol % to about 60 vol % H₂O in air.

Aspect 25. The symmetrical cell of any one of aspects 16-24, wherein operation comprises repeated thermal cycles from a first temperature to a second temperature and back to the first temperature.

Aspect 26. The symmetrical cell of aspect 25, wherein the first temperature is about 100° C. and the second temperature is from about 500 to about 550° C.

Aspect 27. A single electrochemical cell comprising the electrode of any one of aspects 1-15.

Aspect 28. The single electrochemical cell of aspect 27, further comprising a fuel electrode support.

Aspect 29. The single electrochemical cell of aspect 28, wherein the fuel electrode support comprises NiO, one or more perovskite precursors, and a pore former.

Aspect 30. The single electrochemical cell of aspect 29, wherein the one or more perovskite precursors comprise Ba, Ce, Zr, Y, and Yb (BZCYYb).

Aspect 31. The single electrochemical cell of aspect 30, wherein the NiO, the BZCYYb, and the pore former are present in a ratio of about 5:5:2 by weight.

Aspect 32. The single electrochemical cell of any one of aspects 29-31, wherein the pore former comprises starch.

Aspect 33. The single electrochemical cell of any one of aspects 27-32, further comprising a perovskite phase electrolyte material.

Aspect 34. The single electrochemical cell of aspect 33, wherein the perovskite phase electrolyte material comprises BaZrₓCe_{y}Y_{z}Yb_{(1-x-y-z¬)}O_{3-δ}, wherein 0.1≤x≤0.8, wherein 0≤y≤0.8, and wherein 0≤z≤0.3.

Aspect 35. The single electrochemical cell of aspect 33 or 34, wherein the perovskite phase electrolyte material comprises BaZr_{0.1}Ce_{0.7}Y_{0.1}Yb_{0.1}O_{3-δ} (BZCYYb1711), BaZr_{0.4}Ce_{0.4}Y_{0.1}Yb_{0.1}O_{3-δ} (BZCYYb4411), or a combination thereof.

Aspect 36. A device comprising the symmetrical cell of any one of aspects 16-26 or the single electrochemical cell of any one of aspects 27-35.

Aspect 37. The device of aspect 36, wherein the device comprises a fuel cell, an electrolysis cell, a battery, a water splitting device, or any combination thereof.

Aspect 38. The device of aspect 37, wherein the fuel cell comprises a solid oxide fuel cell, a protonic conducting fuel cell, a proton exchange membrane fuel cell, or any combination thereof.

### EXAMPLES

The following examples are put forth so as to provide those of ordinary skill in the art with a complete disclosure and description of how the compounds, compositions, articles, devices and/or methods claimed herein are made and evaluated, and are intended to be purely exemplary of the disclosure and are not intended to limit the scope of what the inventors regard as their disclosure. Efforts have been made to ensure accuracy with respect to numbers (e.g., amounts, temperature, etc.), but some errors and deviations should be accounted for. Unless indicated otherwise, parts are parts by weight, temperature is in ° C. or is at ambient temperature, and pressure is at or near atmospheric.

### Example 1: Structures of the Catalytically Active Atomic Layers for Electrodes

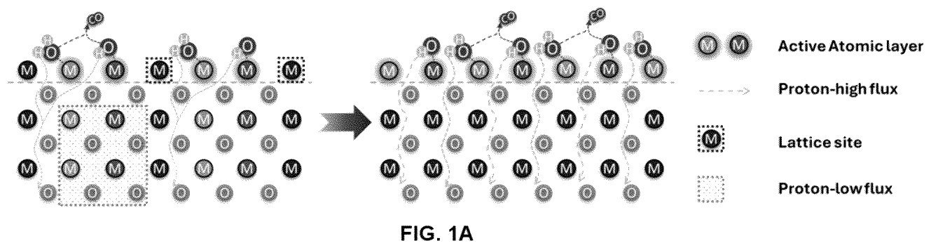

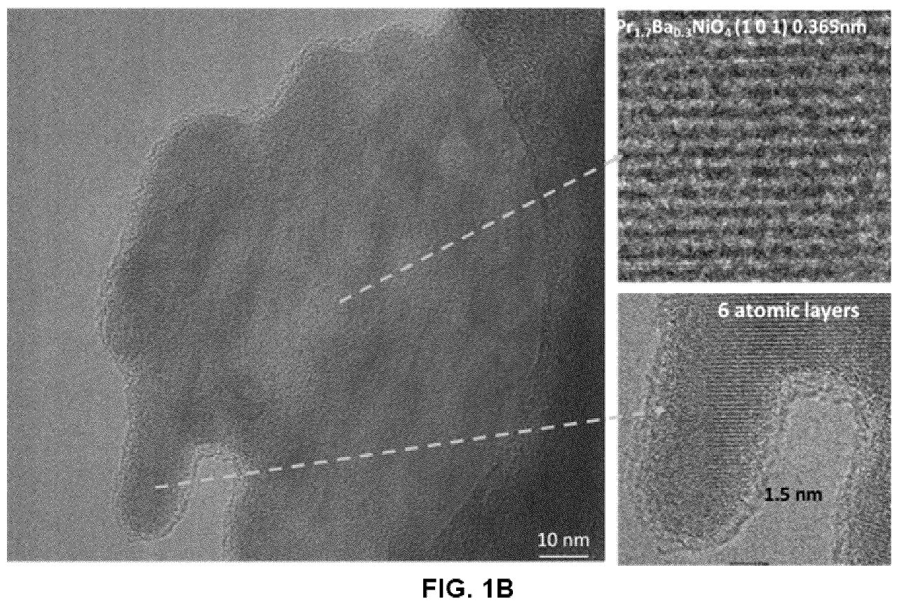

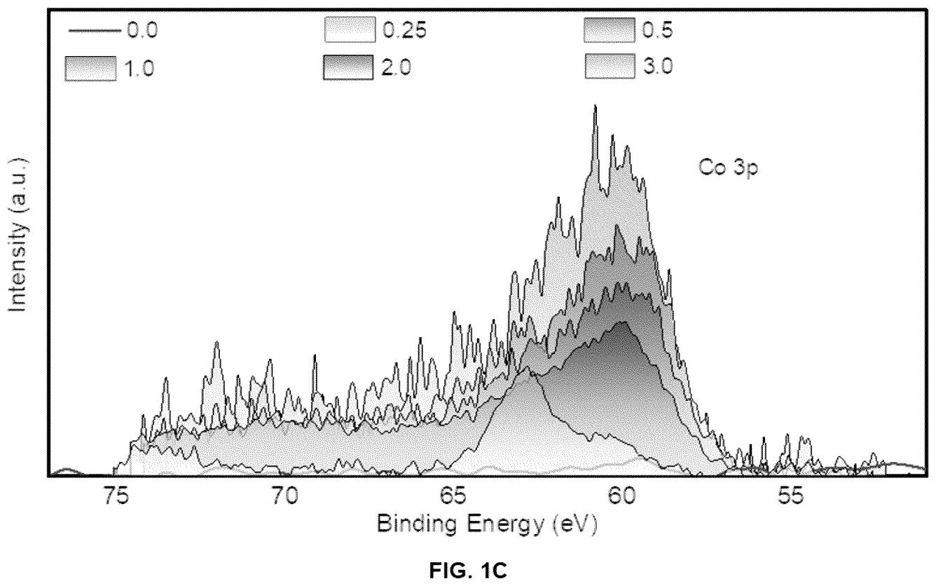

FIG. 1A illustrates the structure of electrode with catalytically active atomic layers. Atomic layer deposition (ALD) allows the formation of nanoscale interfacial mixed layers on pore oxide electrodes, for continuous, uniform atomic layers on an air electrode for BZCYYb1711-based unitized regenerative protonic ceramic electrochemical cells (URPCECs). The kinetic rate of the elementary reactions such as adsorption and dissociation can be significantly changed by elemental modification of the atomic or even subatomic layers, while the electrical conductivity is determined by the intrinsic properties of the substrate. FIG. 1B shows typical morphologies of electrodes with catalytically active atomic layer. X-ray photoelectron spectra (XPS) results (FIG. 1C) further provide evidence of the formation of Co layers.

### Example 2: Fabrication of the Catalytically Active Atomic Layers for Electrodes

Preparation of Air Electrode and Electrolyte Powders. Ruddlesden-Popper phase air electrode materials Pr_{1.8}Ba_{0.3}NiO_{4.1} and perovskite phase electrolyte materials BaZr_{0.1}Ce_{0.7}Y_{0.1}Yb_{0.1}O_{3-δ} were synthesized by ethylenediaminetetraacetic (EDTA)-citric sol-gel method. During synthesis, citric acid and stoichiometric nitrates were first dissolved into distilled water. EDTA as a complexing agent was dissolved into diluted ammonia water. The mole ratio of metal cation:citric acid:EDTA was set to 1:1.5:1. The nitrate and EDTA solutions were then mixed together, followed by adjusting the pH value to 8˜10 using ammonia water or nitric acid. Afterward, the solution was held at ˜80° C. and stirred until gelation on a magnetic heating plate. The gel was heated at 500° C. in the air to decompose nitrates and residual organics. The resultant Pr_{1.8}Ba_{0.2}NiO_{4.1} powders were calcined in air at 1150° C. for 4 h, BaZr_{0.1}Ce_{0.7}Y_{0.1}Yb_{0.1}O_{3-δ} powder in air at 1100° C. for 8 h. Calcined powders were ball-milled in a planetary miller for 12 h.

Fabrication of Symmetrical Cells. To make PBNO∥BCZYYb1711∥PBNO single-phase symmetrical cells, a proportional amount of Zn(NO₃)₂ ethanol solution was added to BCZYYb1711 powders at a ZnO (sintering aid):BCZYYb1711=1:100 wt. ratio, then dried at 22° C. overnight; The electrolyte powders were then pressed to pellets in a 16 mm die at 300 MPa and sintered in air at 1300° C. 4 h for electro pellet support. Single-phase PBNO were blended in an ink vehicle (Fuel Cell Materials Co.), then ground in a mortar until a homogeneous air electrode slurry was formed. The air electrode slurry was then symmetrically screen-printed to the BCZYYb1711 electrolyte with an area of 0.3 cm², followed by sintering at 1100° C. for 3 h. Au paste was applied to the air electrode and fuel electrode as the current collector. Silver wire was used as lead wire.

Fabrication of Single Electrochemical Cells. Electrochemical cells were fabricated with a fuel electrode support∥BCZYYb1711 electrolyte∥air electrode structure. Fuel electrode support powders of NiO:BCZYYb:starch (5:5:2 wt. ratio) were mixed thoroughly. Mixed NiO/BCZYYb powders (6:4 wt ratio) was blended with the ink vehicle to form fuel electrode function slurry. BCZYYb1711 electrolyte powder with 1 wt. % ZnO sintering aid was blended with the ink vehicle to form electrolyte slurry. 0.5 g fuel electrode support powders were pressed to pellets at 200 MPa in the 16 mm die, then spin-coated with one layer of fuel electrode function and two layers of electrolyte slurry. PBNO slurry was screen-printed to the electrolyte, followed by sintering at 1150° C. for 2 h to yield single-phase PBNO cell.

Fabrication of catalytically active atomic layers. PBNO∥BZCYYb1711∥PBNO SCC (scaffold conformal coating) symmetrical cells were used to demonstrate the effect of single elements decorating the surface. SCC fuel cells were used for characterizing the electrolysis operational performance. Representative elements of transition metal, alkaline earth, and lanthanide were chosen to explore the influence of surface decorating. The precursors used in this study were tetramethyl-heptanedionato (TMHD)-type precursors, Ba(TMHD)₂, Sr(TMHD)₂, Zn(TMHD)₂, Cu(TMHD)₂, Ni(TMHD)₂, La(TMHD)₃, Pr(TMHD)₃, Co(TMHD)₃, Sm(TMHD)₃, and bis(cyclopentadienyl) iron (ferrocene).

Electrochemical impedance measurements were performed on symmetric cells after 2, 5, 10, 15, and 20 deposition cycles of each element with the cell exposed to 40 vol. % H₂O at 550° C. The current collection was achieved with Ag wire and Ag paste. Because there was some variation in the performance of different cells, the effects of ALD modification in each element were measured on the same cell before and after deposition. All cell testing was performed immediately after ramping the temperature to 550° C. at 15° C./min to minimize thermal effects on the ALD films. Growth rates of Co, Fe, Pr were determined gravimetrically using high surface area γ-Al₂O₃ powders as the substrate in order to enhance the accuracy of the measurement, as discussed elsewhere. The measured growth rate for these precursor are, 4.7×10¹³ La-atoms/(cm² cycle), 5.4×10¹³ Pr-atoms/(cm² cycle), 8.4×10¹³ Fe-atoms/(cm² cycle), 7.9×10¹³ Co-atoms/(cm² cycle), 5.2×10¹³ Sr-atoms/(cm² cycle), 9×10¹³ Ni-atoms/(cm² cycle), 4.9×10¹³ Ba-atoms/(cm² cycle), 4.3×10¹³ Zn-atoms/(cm² cycle), 5.1×10¹³ Cu-atoms/(cm² cycle), 5.8×10¹³ Sm-atoms/(cm² cycle). TEM image on PBNO powders deposited by 50 Co cycles revealed a uniform coating of CoOX amorphous, validating the efficiency of ALD as a surface tailoring approach.

### Example 3: Electrochemical Measurements

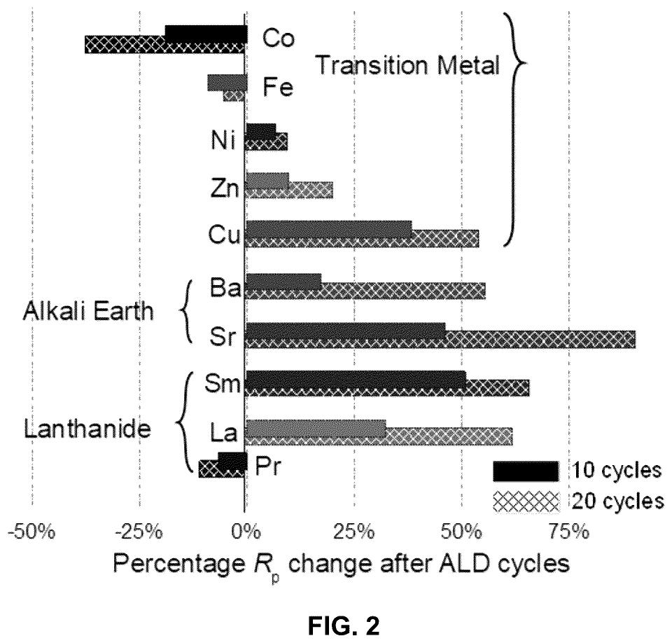

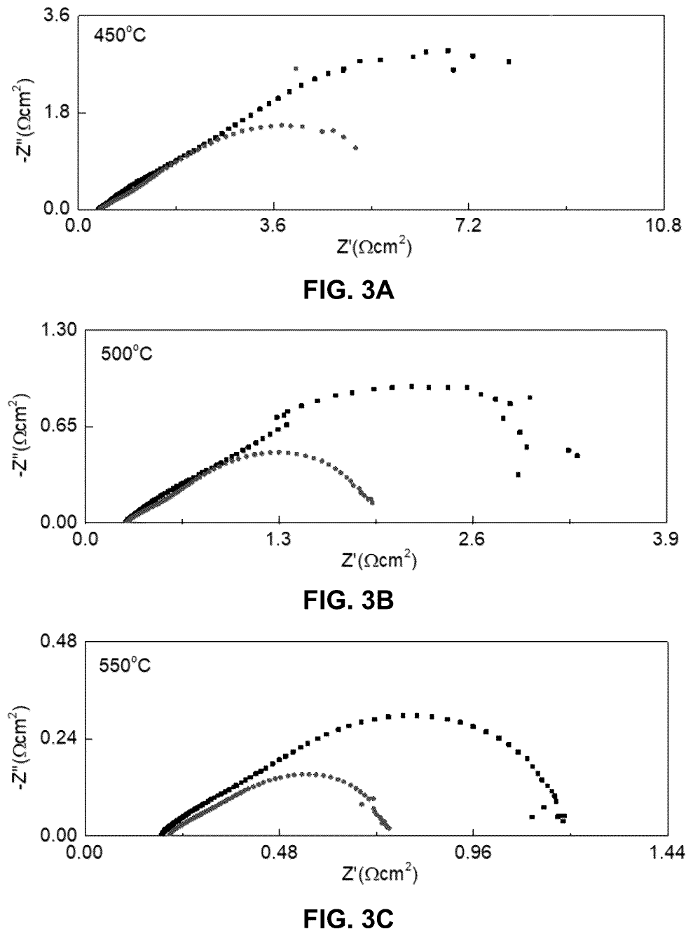

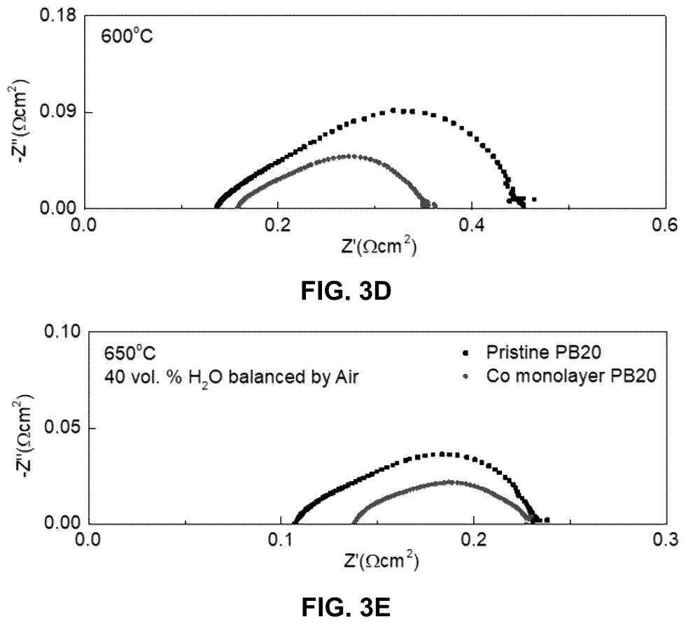

On PBNO SCC symmetrical cells, the effect of representative elements of transition metal (Fe, Co, Ni, Cu, Zn), alkaline earth (Ba, Sr) and lanthanide (La, Sr, Sm) were investigated. FIGS. 3A-3E show representative impedance spectra for a PBNO SCC electrode as a function of the number of ALD cycles at 550° C. and in a 40 vol. % H₂O balanced by air environment (the ohmic part of each spectrum has been subtracted to facilitate comparison). Starting from similar Rₚ, the addition of Ba, Sr, Sm, La, Ni, Zn, and/or Cu shows negative effects on the performance of the PBNO electrode and increases Rₚ, regardless of the oxide coverage; Fe and Pr have relatively smaller positive effects, whereas the addition of Co on the surface of PBNO has a dramatic positive effect, reducing the initial Rₚ from 0.8Ω cm² to 0.5Ω cm² at 550° C. FIG. 2 shows a summary of the findings allowing contrast observations. For simplification, the ohmic drop of the electrolyte has been subtracted.

Cobalt is one of the most successful single elements in electrode improvement by ALD, as previously mentioned. To study the influence of Co ALD on operational performance, two identical PCECs were constructed with the porosity optimal PBNO SCC electrode. Co was deposited for 20 cycles in one of these two cells.

The I-V curve and EIS of the corresponding cells were measured at different temperatures with dry H₂ fed to the fuel electrode and 40 vol. % H₂O to the air electrode. FIGS. 3A-3E show the Nyquist plots of two cells. As can be gleaned from this figures, the Co deposition successfully reduced the ASR by 50%, 46%, 36%, 22%, and 2% at 450° C., 500° C., 550° C., 600° C., and 650° C., respectively.

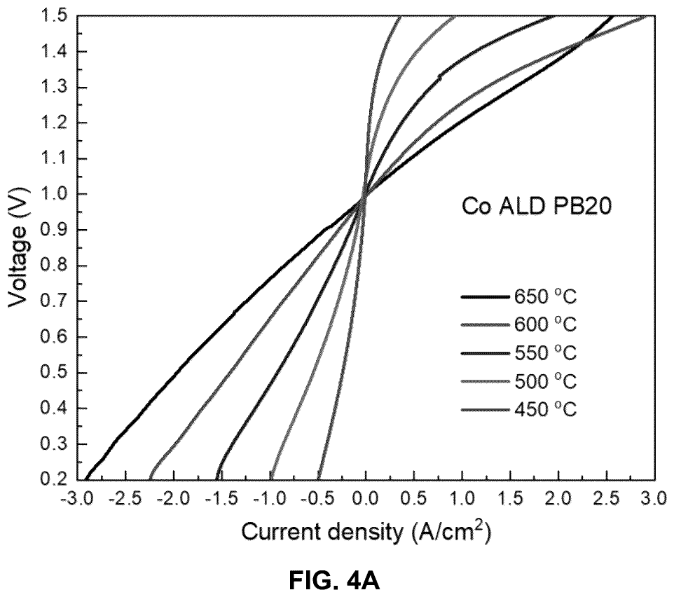

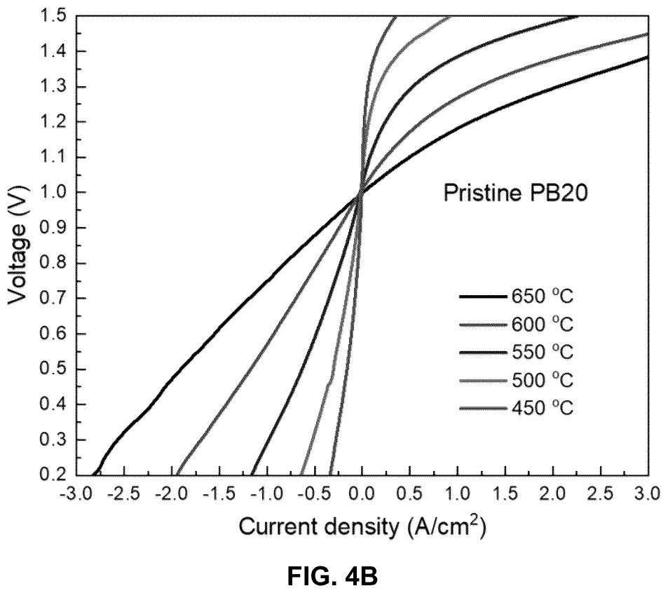

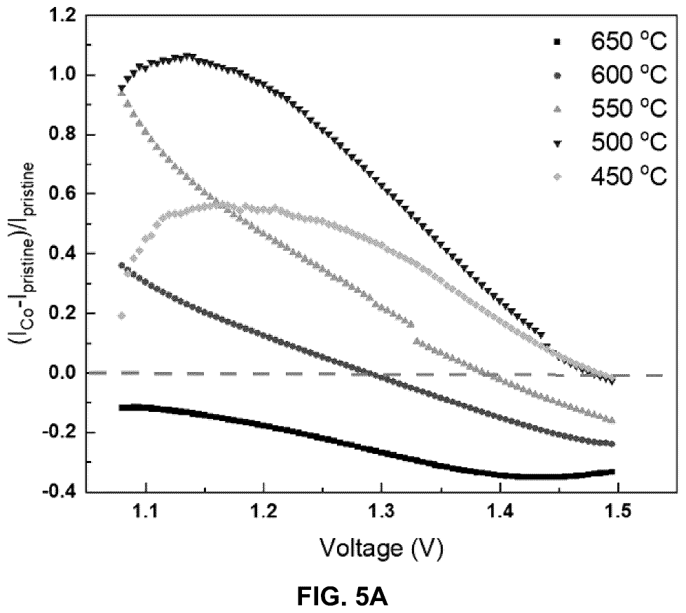

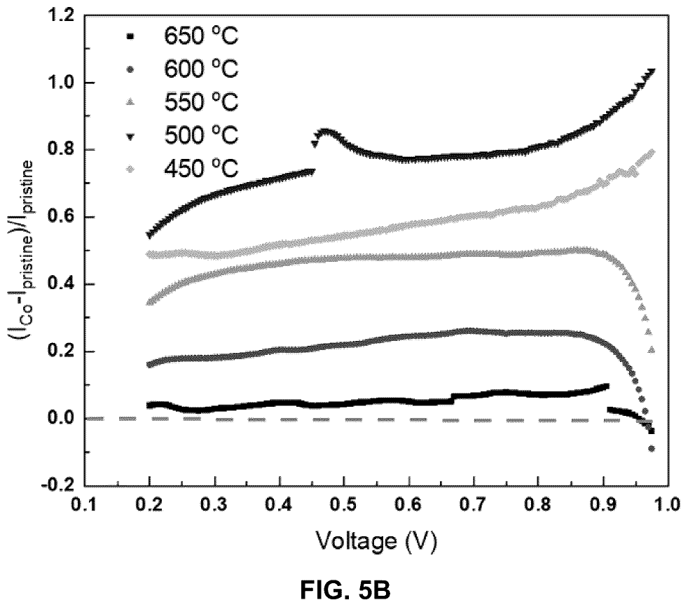

FIGS. 4A-4B show the I-V curves of the two samples with pristine PBNO air electrode and Co deposited PBNO air electrode. The corresponding cell reached 0.532 A/cm² and 0.675 A/cm² at 550° C. and 0.17 A/cm² and 0.29 A/cm² at 500° C. with 1.3 V. FIGS. 5A-5B summarize the difference in electrolysis current of the two cells operating at the same overpotentials. The Co deposition strategy effectively promotes the electrolysis current at low overpotential and low-temperature range, namely improving the operational response, whereas at elevated temperature and overpotential voltage, the Co deposition even presents a negative effect. This phenomenon may be because that the cell is mass transfer controlled rather than charge transfer controlled at elevated temperature and voltage. At temperatures near to dehydration, H₂O adsorption and proton defect concentrations are typically minimal (650° C.). Although the slow charge transfer step can be accelerated, deposition of Co on the surface reduces the effective surface-active site for proton-related species adsorption.

The promotion of electrolysis current at low overpotential and low-temperature range is practically meaningful, as the operating voltage of electrolysis cell in practical operation rarely exceeds the thermal neutral voltage (˜1.29 V at 600° C.), beyond which massive Joule heat will be produced, and the faradic efficiency will drastically decrease. The best promotion is observed at 500° C., and the Co deposition can amazingly provide 81%˜106% (<thermal neutral voltage) performance enhancements without advanced microstructure engineering.

### Example 4: Co as a Surface Catalyst on the Fuel Cell

Cobalt is one of the most successful single elements in electrode improvement by ALD, as previously mentioned. To study the influence of Co ALD on operational performance, two identical PCECs were constructed with the porosity optimal PB20 SCC electrode. Co was deposited for 20 cycles in one of these two cells.

The I-V curve and EIS of the corresponding cells were measured at different temperatures with dry H₂ fed to the fuel electrode and 40 vol. % H₂O to the air electrode. FIGS. 3A-3E show the Nyquist plots of two cells. As can be gleaned from these figures, the Co deposition successfully reduced the ASR by 50%, 46%, 36%, 22% and 2% at 450° C., 500° C., 550° C., 600° C. and 650° C., respectively.

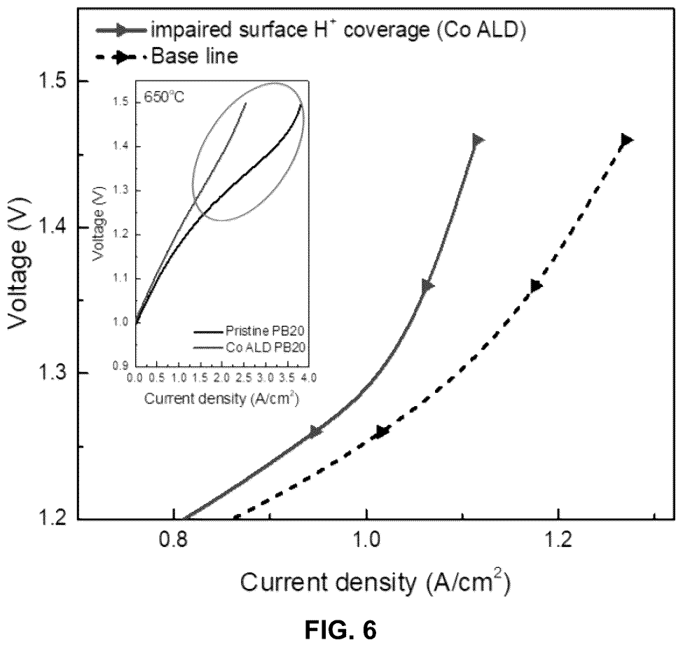

FIGS. 4A-4B show the I-V curves of the two samples with pristine PB20 air electrode and Co deposited PB20 air electrode. The corresponding cell reached 0.532 A/cm² and 0.675 A/cm² at 550° C. and 0.17 A/cm² and 0.29 A/cm² at 500° C. with 1.3 V. FIG. 5A summarizes the difference in electrolysis current of the two cells operating at the same overpotentials. The Co deposition strategy effectively promotes the electrolysis current at low overpotential and low-temperature range, namely improving the operational response, whereas at elevated temperature and overpotential voltage, the Co deposition even presents a negative effect. This phenomenon may be because that the cell is mass transfer controlled rather than charge transfer controlled at elevated temperature and voltage. At temperatures near to dehydration, H₂O adsorption and proton defect concentrations are typically minimal (650° C.). Although the slow charge transfer step can be accelerated, deposition of Co on the surface reduces the effective surface-active site for proton-related species adsorption (equilibrium H⁺ coverages in modeling). As a result, the available reactant on the surface may not be sufficient to produce the huge electrolysis current at higher temperatures. An electrochemical simulation was performed using the previously created kinetic model to demonstrate the I-V behavior of two materials at 650° C. (FIG. 6). The simulated I-V curve shows a similar decreased growth rate at the higher voltage by impairing the equilibrium H⁺ coverage by −50% (labeled as Co ALD in FIG. 6).

The promotion of electrolysis current at low overpotential and low-temperature range is practically meaningful, as the operating voltage of electrolysis cell in practical operation rarely exceeds the thermal neutral voltage (˜1.29 V at 600° C.), beyond which massive Joule heat will be produced, and the faradic efficiency will drastically decrease. The best promotion is observed at 500° C., and the Co deposition can amazingly provide 81%˜106% (<thermal neutral voltage) performance enhancements without advanced microstructure engineering.

The performance of this Co deposited PCEC ranks at one of the tops among PCECs operated at intermediate temperature ranges, and it is comparable to the cells using a sophisticated electrode microstructure engineering, such as PLD, in-situ exsolution and 3D texture (Table 1). Similarly to previous work, the performance can be further increased by thinning the electrode thickness to less than 10 μm.

TABLE 1
Electrochemical Performance of Top PCEC
Single Cells in Electrolysis Mode

| Cell Configuration | | | I_{electrolysis} |
|---|---|---|---|
| Air Electrode//[thickness in μm] | Steam | | at 1.3 V |
| electrolyte | [atm] | T[° C.] | [mA · cm⁻²] |
| Pr_{1.8}Ba_{0.2}NiO_{4+δ} (Co ALD)// | 0.4 | 550 | 675 |
| [15]BaZr_{0.1}Ce_{0.7}Y_{0.1}Yb_{0.1}O_{3-δ} | | 500 | 290 |
| Pr_{1.8}Ba_{0.2}NiO_{4+δ} (SCC)// | 0.4 | 550 | 532 |
| [15]BaZr_{0.1}Ce_{0.7}Y_{0.1}Yb_{0.1}O_{3-δ} | | 500 | 170 |
| Pr_{1.7}Ba_{0.3}NiO_{4+δ}// | 0.4 | 550 | 490 |
| [15]BaZr_{0.1}Ce_{0.7}Y_{0.1}Yb_{0.1}O_{3-δ} | | | |
| Pr₂NiO_{4+δ}// | 0.6 | 550 | 250 |
| [15]BaZr_{0.1}Ce_{0.7}Y_{0.1}Yb_{0.1}O_{3-δ} | | | |
| BaCo_{0.4}Fe_{0.4}Zr_{0.1}Y_{0.1}O_{3-δ}// | 0.10 | 550 | 700 |
| [12]BaZr_{0.1}Ce_{0.7}Y_{0.1}Yb_{0.1}O_{3-δ}* | | | |
| PrBa_{0.5}Sr_{0.5}Co₂₋ₓFeₓO_{5+δ} (PLD)// | 0.03 | 550 | 830 |
| [15]BaCe_{0.4}Zr_{0.4}Y_{0.1}Yb_{0.1}O_{3-δ}* | | 500 | 420 |
| PrNi_{0.5}Co_{0.5}O_{3-δ} (3D-texture)// | 0.10 | 550 | 560 |
| [10]BaCe_{0.4}Zr_{0.4}Y_{0.1}Yb_{0.1}O_{3-δ}* | | 500 | 230 |
| PrBa_{0.8}Ca_{0.2}Co₂O_{5+δ} | 0.03 | 550 | 678 |
| (in situ exsolution)// | | | |
| [8]BaZr_{0.1}Ce_{0.7}Y_{0.1}Yb_{0.1}O_{3-δ}* | | | |

*Previously published. Provided for comparison purposes.

Based on PCECs with PBNO SCC electrode, the effect of surface decoration was investigated using transition metal (Fe, Co, Ni, Cu, Zn), alkaline earth (Ba, Sr) and lanthanide (La, Sr, Sm). The addition of Ba Sr Sm La Ni Zn Cu show a negative effect on the Rₚ of PBNO electrode, regardless of the oxide coverage; Fe and Pr have a relatively small positive effect, while the addition of Co on the surface of PBNO yields a dramatic positive effect, reducing the initial Rₚ from 0.8 Ω·cm² to 0.5 Ω·cm² at 550° C. The Fe, Co, Pr ALD presents a similar pattern of positive and negative effects on the individual peaks deconvoluted from EIS spectrum, but to a different extent. DRT analysis indicates that the Rₚ of two O-related peaks were decreased, while Rₚ of the H-related peaks showed a slight increase.

To investigate the effect of Co ALD on operational performance, two identical fuel electrode-supported PCECs were fabricated with the porosity optimum PB20 SCC electrode. One of the two cells was deposited with Co for 20 cycles. Their electrolysis current reached 0.532 A/cm² and 0675 A/cm² at 550° C. and 1.3 V for pristine and Co deposited samples, respectively. The Co deposition strategy effectively promotes the electrolysis current at low overpotential and low-temperature ranges, improving the operational responses below thermal neutral voltage. This Co deposited PCEC has one of the best performances among PCECs operating at moderate temperatures, comparable to cells with advanced electrode microstructure engineering.

It should be emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

What is claimed is:

1. An electrode comprising a Ruddlesden-Popper phase scaffold and a catalyst coating, wherein the catalyst coating comprises a conformal catalyst coating forming a continuous, uniform film over the scaffold, wherein the film is less than about 20 μm thick.

2. The electrode of claim 1, wherein the Ruddlesden-Popper phase scaffold comprises Pr₂₋ₓBaₓNiO_{4+δ}, wherein 0≤x≤0.4.

3. The electrode of claim 1, wherein the catalyst coating comprises a transition metal, a transition metal oxide, or a perovskite.

4. The electrode of claim 3, wherein the transition metal comprises cobalt, iron, praseodymium, an alloy thereof, or any combination thereof.

5. The electrode of claim 3, wherein the perovskite has a formula AB(O₃), wherein A comprises praseodymium, lanthanum, or a combination thereof, and wherein B comprises a second transition metal.

6. The electrode of claim 5, wherein the second transition metal comprises cobalt, iron, or a combination thereof.

7. The electrode of claim 3, wherein the transition metal has been deposited by atomic layer deposition (ALD).

8. The electrode of claim 7, wherein from about 2 to about 50 ALD cycles have been performed.

9. A symmetrical cell comprising the electrode of claim 1.

10. The symmetrical cell of claim 9, further comprising a perovskite phase electrolyte material.

11. The symmetrical cell of claim 10, wherein the perovskite phase electrolyte material comprises BaZrₓCe_{y}Y_{z}Yb_{(1-x-y-z¬)}O_{3-δ}, wherein 0.1≤x≤0.8, wherein 0≤y≤0.8, and wherein 0≤z≤0.3.

12. The symmetrical cell of claim 10, wherein the perovskite phase electrolyte material comprises BaZr_{0.1}Ce_{0.7}Y_{0.1}Yb_{0.1}O_{3-δ} (BZCYYb1711), BaZr_{0.4}Ce_{0.4}Y_{0.1}Yb_{0.1}O_{3-δ} (BZCYYb4411), or a combination thereof.

13. The symmetrical cell of claim 9, wherein the symmetrical cell has a polarization resistance less than about 0.2 Ω·cm².

14. The symmetrical cell of claim 9, wherein a final polarization resistance after 200 hours of operation is no more than about 10% greater than an initial polarization resistance.

15. The symmetrical cell of claim 9, wherein operation comprises repeated thermal cycles from a first temperature to a second temperature and back to the first temperature, wherein the first temperature is about 100° C. and the second temperature is from about 500 to about 550° C.

16. A single electrochemical cell comprising the electrode of claim 1.

17. The single electrochemical cell of claim 16, further comprising a fuel electrode support.

18. The single electrochemical cell of claim 17, wherein the fuel electrode support comprises NiO, one or more perovskite precursors, and a pore former,

19. The single electrochemical cell of claim 18, wherein the one or more perovskite precursors comprise Ba, Ce, Zr, Y, and Yb (BZCYYb).

20. The single electrochemical cell of claim 16, further comprising a perovskite phase electrolyte material, wherein the perovskite phase electrolyte material comprises BaZrₓCe_{y}Y_{z}Yb_{(1-x-y-z¬)}O_{3-δ}, wherein 0.1≤x≤0.8, wherein 0≤y≤0.8, and wherein 0≤z≤0.3.
